(19) United States
(12) Patent Application Publication
(10) Pub. No.: US 2023/0384790 A1
(43) Pub. Date: Nov. 30, 2023

(54) Controlling a Moveable Device Utilizing Risk Control Barrier Functions

(71) Applicant: California Institute of Technology, Pasadena, CA (US)

(72) Inventors: Andrew W. Singletary, Pasadena, CA (US); Aaron D. Ames, Pasadena, CA (US); Mohamadreza Ahmadi, San Diego, CA (US)

(73) Assignee: California Institute of Technology, Pasadena, CA (US)

(21) Appl. No.: 18/324,718

(22) Filed: May 26, 2023

Related U.S. Application Data
(60) Provisional application No. 63/345,956, filed on May 26, 2022.

(51) Int. Cl. G05D 1/02; B60W 50/00

(52) U.S. Cl. CPC G05D 1/0214; B60W 50/0098; B60W 2552/15; B60W 2552/50; B60W 2300/40

(57) ABSTRACT

Disclosed herein is a system and method for controlling a moveable device utilizing risk control barrier functions. In one example, a system for controlling a moveable device includes a processor and memory containing programming executable by the processor. The programming is configured to receive various information about the moveable device and receive a risk tolerance for a user and calculate a risk control barrier function. The programming is configured to receive a command from the user to alter the state of the moveable device; calculate a dynamic coherent risk measurement based on the risk tolerance of the user and in respect to the risk control barrier function in respect to the command from the user to alter the state of the moveable device; determine whether the dynamic coherence risk measurement is beyond a tuning parameter at the current state of the moveable device.

### CROSS-REFERENCE TO RELATED APPLICATIONS

This application claims the benefit of and priority under 35 U.S.C. §119(e) to U.S. Provisional Patent Application Ser. No. 63/345,956 entitled “Risk Control Barrier Functions,” filed May 26, 2022, which is incorporated herein by reference in its entirety for all purposes.

### STATEMENT OF FEDERAL SUPPORT

This invention was made with government support under Grant No. CPS1932091 awarded by the National Science Foundation. The government has certain rights in the invention.

### FIELD OF THE INVENTION

The present invention generally relates to systems and methods for controlling a moveable device utilizing risk control barrier functions.

### BACKGROUND

Autonomous robotic systems are being increasingly deployed in real-world settings where safety is critical. With this transition to practice, the associated risk that stems from unknown and unforeseen circumstances is correspondingly on the rise. In the context of safety-critical scenarios, such as those found in aerospace and human-robot applications, it is essential that decision making accounts for risk. These risks are often associated with uncertainty due to extremely intricate nonlinear dynamics, e.g. bipedal robots, and/or extreme unstructured environments, e.g. subterranean or extraterrestrial exploration.

Making safety guarantees in the presence of uncertainty is a difficult problem. A coherent risk measure is a function of risk that satisfies properties of monotonicity, sub-additivity, homogeneity, and translational invariance. These properties make them computationally friendly to work with, while still covering a large class of functions for assessing risk. There may be numerous advantages to formulating uncertainty as a coherent risk measure, rather than a chance constraint or enforcing safety in expected value. Instead of ignoring the safety threats at all values less than the chosen probability of a chance constraint, risk measures assess those dangers and enforce safety over them.

Mathematically speaking, risk can be quantified in numerous ways, such as chance constraints, exponential utility functions, and/or distributional robustness. However, applications in autonomy and robotics benefit from more nuanced assessments of risk. A coherent risk measure has obtained widespread acceptance in finance and operations research, among other fields. An important example of a coherent risk measure is the conditional value-at-risk (CVaR) that has received significant attention in decision making problems, such as Markov decision processes (MDPs). Stochastic discrete-time dynamical systems have been proposed for Lyapunov conditions for risk-sensitive exponential stability. Moreover, methods based on stochastic reachability analysis to estimate a CVaR-safe set of initial conditions via the solution to an MDP have been previously proposed.

### SUMMARY OF THE INVENTION

Various embodiments are directed to a system for controlling a moveable device including: a processor; and memory containing programming executable by the processor. The programming is configured to: receive characteristics of the moveable device; receive a current state of the moveable device; receive environmental information of the moveable device; receive a risk tolerance for a user; calculate a risk control barrier function based on the characteristics and environmental information of the moveable device; receive a command from the user to alter the state of the moveable device; calculate a dynamic coherent risk measurement based on the risk tolerance of the user and in respect to the risk control barrier function in respect to the command from the user to alter the state of the moveable device; determine whether the dynamic coherence risk measurement is beyond a tuning parameter at the current state of the moveable device;

and control the moveable device based on the determination of whether the dynamic coherence risk measurement is beyond the tuning function.

In some embodiments, the dynamic coherent risk measurement is calculated by: ρ(h(x^{t+1})), where h(x^{t+1}) is the risk control barrier function and x^{t+1} is the altered state of the moveable device.

In some embodiments, the tuning function is a function of the safety at the current state of the moveable device.

In some embodiments, the tuning function is calculated by: α(h(x^{t})), where x^{t} is the current state of the moveable device and where h(x^{t}) is the safety at the current state of the moveable device.

In some embodiments, the tuning function α(h(x^{t})) is a constant.

In some embodiments, determining whether the dynamic coherence risk measurement is beyond a tuning parameter at the current state of the moveable device involves: ρ(h(x^{t+1}))≥α(h(x^{t})), ∀x^{t}∈X.

In some embodiments, the moveable device is a cart-pole including a pole attached to a cart and wherein the altered state of the moveable device is defined by:

$${x}^{t + 1} = {x}^{t} + [ \begin{matrix}{v}_{x} \\ \dot{θ} \\ \frac{{u}^{t} + {m}_{p} sin θ ( l {\dot{θ}}^{2} + g cos θ )}{{m}_{c} + {m}_{p} {sin}^{2} θ} \\ \frac{{u}^{t} cos θ - {m}_{p} l {\dot{θ}}^{2} cos θ sin θ - ( {m}_{c} + {m}_{p} ) g cos θ}{l ( {m}_{c} + {m}_{p} {sin}^{2} θ )}\end{matrix} ] {Δ}_{t} + {w}^{t} ,$$

where vₓ is a current positional velocity of the moveable device, \dot{θ} is an angular velocity of the moveable device, u^{t} is an applied force on the moveable device, mₚ is a mass of the pole, θ is an angle of the moveable device, l is a length of the pole, g is a gravitational constant, m_{c} is the mass of the cart, Δₜ is a time step, and w^{t} is a random disturbance on the moveable device.

In some embodiments, the risk control barrier function in respect to the command from the user to alter the state of the moveable device is defined by: h(x^{t+1})=−2aₘₐₓ(pₓ^{t+1}−p₀)−vₓ^{t+1}^{²} sgn (vₓ^{t+1}), where aₘₐₓ is a maximum acceleration of the moveable device, pₓ^{t+1}−p₀ is an altered relative position of the moveable device to a barrier constraint, and vₓ^{t+1} is the altered velocity of the moveable device.

In some embodiments, the dynamic coherence risk measurement is determined to be less than the tuning parameter and the moveable device is controlled in a way which is different than the command from the user.

In some embodiments, the dynamic coherence risk measurement is determined to be greater than or equal to the tuning parameter and the moveable device is controlled in line with the command from the user to alter the state of the moveable device.

In some embodiments, the moveable device is a boat, a plane, a drone, a car, or a robot.

In some embodiments, the state of the moveable device is a position, speed, and/or traveling direction of the moveable device.

In some embodiments, the environmental information of the moveable device includes a barrier, a slope, a hill, and/or a user defined distance from the barrier.

In some embodiments, the command from the user of alter the state of the moveable device includes a change of speed, direction, angle, and/or force on the moveable device.

In some embodiments, the tuning function is calculated by: ϵ(1−γ)+γh(x^{t}), where ϵ and γ are constants, where 0<γ<1 and ϵ>0, where x^{t} is the current state of the moveable device, and where h(x^{t}) is the safety at the current state of the moveable device.

In some embodiments, determining whether the dynamic coherent risk measurement is beyond a tuning parameter at the current state of the moveable device involves: ρ(h(x^{t+1}))−γh(x^{t})≥ϵ(1−γ), ∀x^{t}∈X.

Further, various embodiments are directed to a method for controlling a moveable device, the method including: receiving characteristics of the moveable device; receiving a current state of the moveable device; receiving environmental information of the moveable device; receiving a risk tolerance for a user; calculating a risk control barrier function based on the characteristics and environmental information of the moveable device; receiving a command from the user to alter the state of the moveable device; calculating a dynamic coherent risk measurement based on the risk tolerance of the user and in respect to the risk control barrier function in respect to the command from the user to alter the state of the moveable device; determining whether the dynamic coherence risk measurement is beyond a tuning parameter at the current state of the moveable device; and controlling the moveable device based on the determination of whether the dynamic coherence risk measurement is beyond the tuning function.

In some embodiments, the dynamic coherent risk measurement is calculated by: ρ(h(x^{t+1})), where h(x^{t+1}) is the risk control barrier function and x^{t+1} is the altered state of the moveable device.

In some embodiments, the tuning function is calculated by: α(h(x^{t})), where x^{t} is the current state of the moveable device.

In some embodiments, determining whether the dynamic coherence risk measurement is beyond a tuning parameter at the current state of the moveable device involves: ρ(h(xₜ₊₁))≥α(x^{t})), ∀x^{t}∈X.

### BRIEF DESCRIPTION OF THE DRAWINGS

The description will be more fully understood with reference to the following figures and data graphs, which are presented as various embodiment of the disclosure and should not be construed as a complete recitation of the scope of the disclosure, wherein:

FIG. 1 illustrates these notions for an example h variable with distribution p(h).

FIG. 2 is simulation results for the cart-pole system with no RCBF filter, and with standard RCBF (top) and finite-time RCBF (bottom) filters using total conditional expectation and CVaR.

FIG. 3 illustrates an example of safety system for computing a safe state for a moveable device in accordance with an embodiment of the invention.

FIG. 4 illustrates an example of a safety computation element that executes instructions to perform processes that computes safety for moveable devices in accordance with an embodiment of the invention.

FIG. 5 illustrates a flow chart for a method for controlling a moveable device in accordance with an embodiment of the invention.

### DETAILED DESCRIPTION

Various embodiments of the disclosure relate to enforcing safety over coherent risk measurements using risk Control Barrier Functions (CBFs). Described herein is a framework for enforcing control barrier functions over general coherent risk measures. Techniques exist for using coherent risk measures inside of model-predictive controllers (MPC), but the advantages to using CBFs are numerous. For one, it has been discovered that control barrier functions are much less computationally expensive than MPCs, as they do not have to look ahead for a window of time. Moreover, control barrier functions may include no model simplification to be utilized, and can be enforced with the full, nonlinear dynamics. Thus, CBFs can provide formal guarantees of safety for the system.

Risk Control Barrier Functions (RCBFs) are methods for enforcing safety in the presence of stochastic uncertainty. RCBFs may guarantee safety with respect to dynamic coherent risk measures, which serve as a computationally efficient means to assess risk. Moreover, finite-time RCBFs can be utilized to provide convergence to a set in finite time, resulting in a practical safety filter that works both inside and outside of the safe set. Multiple safe sets can be enforced simultaneously utilizing Boolean compositions. Finally, the efficacy of this framework may be utilized on various systems such as a nonlinear cart-pole system under stochastic uncertainty.

Guaranteeing safety for robotic and autonomous systems in real-world environments is a challenging task that may include mitigation of stochastic uncertainties. Control barrier functions have been widely used for enforcing safety related set-theoretic properties, such as forward invariance and reachability, of nonlinear dynamical systems. Various embodiments of the invention include utilizing control barrier functions in nonlinear discrete-time systems subject to stochastic uncertainty and a framework for assuring risk-sensitive safety in terms of coherent risk measures. Risk control barrier functions (RCBFs) may include barrier functions and dynamic, coherent risk measures. RCBFs imply invariance in a coherent risk sense. Furthermore, finite-time RCBFs may guarantee finite-time reachability to a desired set in the coherent risk. Disclosed herein are conditions for risk-sensitive safety and finite-time reachability of sets composed of Boolean compositions of multiple RCBFs. Embodiments including RCBFs to enforce safety may be utilized in a cart-pole system in a safety-critical scenario.

One advantage for using risk control barrier functions over general probabilistic control barrier functions, include its ability to assess the danger of low-probability events, without being overly conservative. A chance constraint enforced at every time-step may eventually be broken, and attempting to enforce safety for all possible values of uncertainty would be too conservative, so risk measures provide a middle-ground that results in better performance.

Described below is one example of a method to enforce safety on a non-linear cart-pole system. However, safety may be enforced with this method on any discrete-time, nonlinear system. Any coherent risk measure can be used, and the example given is Conditional Value at Risk (CVaR).

Examples beyond a non-linear cart-pole system where risk CBFs include but are not limited to autonomous driving with sensor noise, industrial robots with humans in the environment, or drones with other agents flying around them. All of these systems have uncertainty, and risk CBFs can be used to enforce safety of their discrete-time models.

In some embodiments, the risk-sensitive safety is based on a special class of control barrier functions. Control barrier functions have been used for designing safe controllers (in the absence of a legacy controller, e.g., a desired controller that may be unsafe) and safety filters (in the presence of a legacy controller) for continuous-time dynamical systems, such as bipedal robots and trucks, with guaranteed robustness. For discrete-time systems, discrete-time barrier functions may be applied to the multi-robot coordination problem. Recently, for a class of stochastic (Ito) differential equations, safety in probability and statistical mean may be used in stochastic barrier functions.

Conventional notions of safety in probability and statistical methods through the use of coherent risk measures are described below. To this end, for discrete-time systems subject to stochastic uncertainty, defined below are safety and finite-time reachability in the risk-sensitive sense, e.g., in the context of the worst possible realizations, via coherent risk measures. Risk control barrier functions (RCBFs) are described together with finite-time RCBFs, as a tool to enforce risk-sensitive safety and reachability, respectively. Various embodiments of the invention include RCBFs to ensure safety in a risk sensitive fashion. Finite-time RCBFs may allow for the extension of this result to risk-sensitive reachability. Furthermore, for safe and goal sets defined as Boolean compositions of multiple function level-sets, conditions are described that ensure safety and reachability of these sets based on RCBFs and their finite-time counterparts. Importantly, in all cases, the risk-sensitive controllers are designed to be minimally invasive with respect to a given system legacy controller.

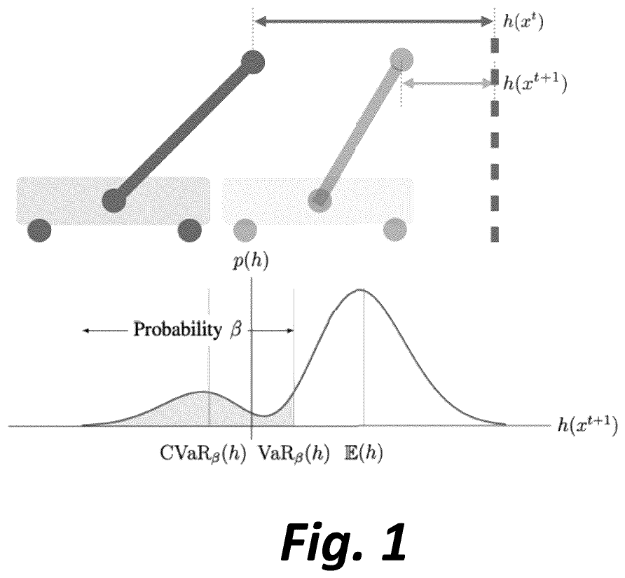

Turning to the drawings, FIG. 1 is a value of a safe-set h(x^{t}) known at time t, but stochastic uncertainty makes h(x^{t+1}) a random variable. u^{t} may be chosen such that h(x^{t+1}) is safe subject to a risk measure taken over the worst β probability. [symbol] ⁿ may denote the n-dimensional Euclidean space and [symbol] _{≥0} the set of non-negative integers. For a finite set [symbol] , [symbol] may denote the number of elements of [symbol] . For a probability space (X, [symbol] , [symbol] ) and a constant p∈[1, ∞), [symbol] ₚ(X, [symbol] , [symbol] ) may denote the vector space of real valued random variables X for which [symbol] |X|^{p}<∞. The Boolean operators are denoted by ¬ (negation), v (conjunction), and Λ (disjunction). For a risk measure or a function ρ, ρ^{t} may be utilized to show the function composition of ρ with itself t times.

### Example Coherent Risk Measures

Conditional risk measures with a view toward defining risk control barrier functions is described below. In this context, a probability space (Ω, [symbol] , [symbol] ), a filtration [symbol] ₀⊂. . . [symbol] _{N}⊂ [symbol] , and an adapted sequence of random variables h^{t}, t=0, . . . , N, where N∈ [symbol] _{≥0} ∪{∞} are utilized. For t=0, . . . , N, the spaces [symbol] ₜ= [symbol] ₚ(Ωn, [symbol] , [symbol] ), p∈[0, ∞), [symbol] _{t:N}= [symbol] ₜ× . . . ×Z_{N} and [symbol] = [symbol] ₀× [symbol] ₁×. . . may be defined. It may be assumed that the sequence h∈ [symbol] is almost surely bounded (with exceptions having probability zero), e.g., ess supₜ|h^{t}(ω)<∞. In order to describe how to evaluate the risk of sub-sequence hₜ, . . . , h_{N} from the perspective of stage t, the following definitions are applicable.

Definition 1 (Conditional Risk Measure): A mapping ρ_{t:N}: [symbol] _{t,N}→ [symbol] ₜ, where 0≤t≤N, is called a conditional risk measure, if it has the following monotonicity property: ρ_{t:N}(h)≤ρ_{t:N}(h′), ∀h, ∀h′∈ [symbol] _{t:N} such that h≤h′. A dynamic risk measure is a sequence of conditional risk measures ρ_{t:N}: [symbol] _{t:N}→ [symbol] ₜ, t=0, . . . , N.

One fundamental property of dynamic risk measures is their consistency over time. That is, if h will be as good as h′ from the perspective of some future time θ, and they are identical between times T and θ, then h should not be worse than h′ from the perspective at time T. If a risk measure is time-consistent, the one-step conditional risk measure ρₜ: [symbol] ₜ→ [symbol] ₜ₋₁, t=0, . . . , N−1 can be defined as follows:

ρₜ(h^{t})=ρ_{t-1,t}(0, h^{t}), (1)

and for all t=1, . . . , N, the following may be obtained:

ρ_{t,N}(h^{t}, . . . , h^{N})=ρₜ(h^{t}+ρₜ₊₁(h^{t+1}+ρₜ₊₂(h^{t+1}+. . . +ρ_{N-1}(h^{N-1}+ρ_{N}(h^{N})) . . . ))). (2)

Note that the time-consistent risk measure is completely defined by one-step conditional risk measures ρₜ, t=0, . . . , N−1 and, in particular, for t=0, (2) defines a risk measure of the entire sequence h∈ [symbol] _{0:N}. This leads to the notion of a coherent risk measure.

Definition 2 (Coherent Risk Measure): The one-step conditional risk measures ρₜ: [symbol] ₜ₊₁→ [symbol] ₜ, t=1, . . . N−1 as in (2) a coherent risk measure if it satisfies the following conditions
Convexity: ρₜ(λh+(1−λ)h′)≥λρₜ(h)+(1−λ)ρₜ(h′), for all λ∈(0,1) and all h, h′∈ [symbol] ₜ;
Monotonicity: If h≥h′ then ρₜ(h)≥ρₜ(h′) for all h, h′∈ [symbol] ₜ;
Translational Invariance: ρₜ(h+h′)=c+ρₜ(h′) for all h∈ [symbol] ₜ₋₁ and h′∈ [symbol] ₜ;
Positive Homogeneity: ρₜ(βh)=βρₜ(h) for all h∈ [symbol] ₜ and β≥0.

All risk measures are time-consistent coherent risk measures. Two examples of coherent risk measures have been developed:

Total Conditional Expectation: The simplest risk measure is the total conditional expectation given by

ρₜ(h^{t})= [symbol] [h^{t} [symbol] ₜ₋₁].

Total conditional expectation may satisfy the properties of a coherent risk measure as outlined in Definition 2. Unfortunately, total conditional expectation is agnostic to realization fluctuations of the stochastic variable h and is only concerned with the mean value of h at large number of realizations. Thus, it is a risk-neutral measure of performance.

Conditional Value-at-Risk: Let h★ [symbol] be a stochastic variable for which higher values are of interest. For example, greater values of h indicate safer performance. For a given confidence level β∈(0, 1), value-at-risk (VaR_{β}) denotes the β-quantile value of a stochastic variable h∈ [symbol] described as VaR_{β}(h)= [symbol] {ç| [symbol] (h≤ç)≤β}. Unfortunately, working with VaR for non-normal stochastic variables is numerically unstable, optimizing models involving VaR are intractable in high dimensions, and VaR ignores the values of h with probability less than β.

In contrast, CVaR overcomes the shortcomings of VaR. CVaR with confidence level β∈(0,1) denoted CVaR_{β} measures the expected loss in the β-tail given that the particular threshold VanR_{β} has been crossed, e.g., CVaR_{β}(h)= [symbol] [h|h≤VaR_{β}(h)]. That is, CVanR_{β} is given by

$${CVaR}_{β} ( h ) := - {inf}_{ϛ ∈ ℝ} 𝔼 [ ϛ + \frac{{( - h - ϛ )}_{+}}{β} ] . \qquad ( 4 )$$

Note that the above formulation of CVaR is concerned with the left-tail of distributions (higher values of h are preferred).

A value of β→1 corresponds to a risk-neutral case, e.g., CVaR₁(h)= [symbol] (h); whereas, a value of β→0 is rather a risk-averse case, e.g., CVaR₀(h)=VaR₀(h)=ess inf(h). FIG. 1 illustrates these notions for an example h variable with distribution p(h).

### Risk-Sensitive Safety and Reachability

The robot dynamics of interest may be described by a discrete-time stochastic system given by:

x^{t+1}=f(x^{t}, u^{t}, w^{t}), x₀=x₀, (5)

where t∈ [symbol] _{≥0} denotes the time index, x∈X⊂ [symbol] ⁿ is the state, u∈ [symbol] ⊂ [symbol] ^{m} is the control input, w∈W is the stochastic uncertainty/disturbance, and the function f: [symbol] ⁿ× [symbol] × [symbol] → [symbol] ⁿ. The initial condition x₀ may be deterministic and /W/ may be finite, e.g., W={w₁, . . . , w_{|W|}}. At every time-step t, for a state-control pair (x^{t}, u^{t}), the process disturbance w^{t} is drawn from set W according to the probability mass function p(w)=[p(w₁), . . . , p(w_{|W|})]^{T}, where p(wᵢ):= [symbol] (w^{t}=wᵢ), i=1,2, . . . , |W|. Note that the probability mass function for the process disturbance is time-invariant, and that the process disturbance is independent of the process history and of the state-control pair (x^{t}, u^{t}).

Note that, in particular, system (5) can capture stochastic hybrid systems, such as Markovian Jump Systems. The properties of the solutions to (5) with respect to the compact set S may be described by:

S:={x∈X|h(x)≥0}

Int(S):={x∈X|h(x)>0},

∂S:={x∈X|h(x)=0}, (6)

where h: X→ [symbol] is a continuous function.

In the presence of stochastic uncertainty w, assuring almost sure (with probability one) invariance or safety may not be feasible. Moreover, enforcing safety in expectation may only be meaningful if the law of large numbers can be invoked and in the long term performance, independent of the realization fluctuations. However, instead, safety in the dynamic coherent risk measure sense may be achieved with conditional expectation as an special case.

Definition 3 (ρ-Safety): Given a safe set S as given in (6) and a time-consistent, dynamic coherent risk measure ρ₀:t as described in (2), the solutions to (5), starting at x₀∈S, ρ-safe if and only if

ρ_{0,t}(0,0, . . . , h(x))≥0, ∀t∈ [symbol] _{≥0}. (7)

In order to understand (7), consider the case where p is the conventional total expectation. Then, (7) implies safety in expectation. As mentioned earlier, the definition of safety for general coherent risk measures goes beyond the traditional total expectation.

Another interesting property arises when x₀∈X\S. That is, when instead of safety, a set of interest in finite time is reached.

Definition 4 (ρ-Reachability): In cases of system (5) with initial condition x₀ E X\S, given a set S as given in (6) and a time-consistent, dynamic coherent risk measure ρ_{0:t} as described in (2), the set S is considered ρ-reachable, if and only if there exists a constant t* such that

ρ_{0,t*}(0,0, . . . , h(x))≥0. (8)

### Risk Control Barrier Functions (RCBFs)

Various embodiments of the disclosure include the implementation of one or more Risk Control Barrier Functions (RCBFs). One or more RCBFs may be utilized to verify and enforce risk sensitive safety, e.g., ρ-safety. A finite-time variation may allow the establishment of risk-sensitive reachability, e.g., ρ-reachability.

### Risk Sensitivity Safety with RCBFs

Definition 5 (Risk Control Barrier Function): For the discrete-time system (5) and a dynamic coherent risk measurement ρ, the continuous function h: [symbol] ⁿ→ [symbol] is a risk control barrier function for the set [symbol] as defined in (6), if there exists a convex α∈ [symbol] satisfying α(r)<r for all r>0 such that

ρ(h(x^{t+1}))≥α(h(x^{t})), ∀x^{t}∈X. (9)

h(x^{t}) defines the RCBF at state x^{t} whereas h(x^{t+1}) defines the RCBF at state x^{t+1}. In order to achieve the definition of a RCBF, that condition is met for all x^{t} in the set X, which is just the domain of the system. The dynamic coherent risk measurement p is based on the risk tolerance of the user and includes as an input the RCBF at state x^{t+1}. State x^{t+1} is the command from the user to alter the state of a moveable device whereas state x^{t} is the current state. In some embodiments, the moveable device may be a boat, a plane, a drone, a car, or a robot.

α(h(x^{t})) is a tuning function. In one example, the tuning function is a tuning parameter α=α₀, where α₀∈(0,1) is a constant. In some embodiments, α may be set held constant between 0 and 1. An RCBF may signify invariance/safety in the coherent risk measure.

In the discrete-time system (5) and the set S as described in (6), ρ may be a given coherent risk measure. Then, S is ρ-safe if there exists an RCBF as defined in Definition 5.

If (9) holds, for t=0, then

ρ(h(x¹))≥α(h(x₀)). (10)

Similarly, for t=1, then:

ρ(h(x²))≥α(h(x¹)) (11)

Since ρ is monotone, composing both sides of (11) with ρ does not change the inequality which yields

ρ°ρ(h(x²))≥ρ(α(h(x¹))). (12)

Since α is a convex function, in Jensen's Inequality for coherent risk measures, in particular, if α∈(0,1) is a constant, from positive homogeneity property of ρ, then:

ρ°ρ(h(x²))≥ρ(α(h(x¹)))≥α(ρ(h(x⁰)))

Then, using inequality (10):

ρ°ρ(h(x²))≥ρ(α(h(x¹)))≥α(ρ(h(x₀)))

Therefore, by induction, at time t, α^{t}(h(x^{t}))≥α^{t}(h(x₀)). The left-hand side of the above inequality is equal to ρ_{0,t}(0, . . . , h(x^{t})). Hence:

ρ_{0,t}(0, . . . , h(x^{t})≥α^{t}(h(x₀) (13)

If x∈S, from the definition of the set S, h(x₀)≥0. Since α∈K, then (7) holds. Thus, the system is ρ-safe.

Note that, in the case when x₀∈X\S, the existence of an RCBF implies asymptotic convergence to the set S in the coherent risk measure ρ. This can be inferred from (13). In fact, if α(r)<r, then there exist a constant δ∈(0,1) such that α(r)<δr and hence

α^{t}(r)≤δ^{t}r, t∈ [symbol] _{≥0} (14)

If x₀∈X\S, then h(x₀)<0. However, from (14), as t→∞°. . . °α(r)→0, since the compositions of class K functions is also class K (hence non-negative). Obtaining ρ_{0,t}(0, . . . , h(x^{t})≥0, implies that the solutions become ρ-safe.

If (9) is true then a user's command for a change of state of a moveable device is safe. Otherwise, if (9) is false then a user's command for a change of state is not-safe. When the user's command for a change of state of the moveable device is safe then the system can control the moveable device in the way that the user has commanded. If the user's command for the change of state of the moveable device is not-safe then the user's command may be altered until a safe change of state is reached. When a safe change of state is reached then the system can control the moveable device with this altered user's command.

### Risk Sensitive Safety with Finite-Time RCBFs

System specifications may be characterized by the set S in finite time. Various embodiments may include finite-time RCBFs.

Definition 7 (Finite-Time RCBF): For the discrete-time system (5) and a dynamic coherent risk measure p, the continuous function h:X→ [symbol] is a finite-time RCBF for the set S as defined in (6), if there exist constants 0<γ<1 and ϵ>0 such that

ρ(h(x^{t+1}))−γh(x^{t})≥ϵ(1−γ), ∀x^{t}∈X. (15)

The existence of a finite-time RCBF implies p-reachability. h(x^{t}) defines the RCBF at state x^{t} whereas h(x^{t+1}) defines the RCBF at state x^{t+1}. The dynamic coherent risk measurement ρ is based on the risk tolerance of the user and includes as an input the RCBF at state x^{t+1}. State x^{t+1} is the command from the user to alter the state of a moveable device whereas state x^{t} is the current state. 0<γ<1 and ϵ>0 such that the condition can be met for all x^{t} in your domain X. These may be used to prove that h(x^{t}) is a finite-time RCBF. γ and ϵ may have no inherent meaning separately, but together, they formulate how quickly a system reaches safety when outside of the set (as given by t* below).

Theorem 8: Consider the discrete-time system (5) and a dynamic coherent risk measure ρ. Let S⊂X be as described in (6). If there exists a finite-time RCBF h: X∵ [symbol] as in Definition 7, then for all x⁰∈X\S, there exists a t*∈ [symbol] _{≥0} such that S is ρ-reachable, i.e., inequality (8) holds. Furthermore,

$${t}^{*} \leq log ( \frac{ε - h ( {x}^{0} )}{ε} ) / log ( \frac{1}{γ} ) , \qquad ( 16 )$$

where the constants γ and ϵ are as defined in Definition 7.

Similar to the discussion of Theorem 1, induction and properties of coherent risk measures may be utilized. Utilizing induction, from (15), ρ(h(x^{t+1}))−ϵ≥γh(x^{t})−γϵ=γ(h(x^{t})−ϵ). Hence, for t=0:

ρ(h(x¹))−ϵ≥γ(h(x₀)−ϵ). (17)

For t=1:

ρ(h(x²))−ϵ≥γ(h(x¹)−ϵ). (18)

Since ρ is monotone, composing both sides of the above inequality with ρ does not change the inequality and:

ρ°ρ(h(x²)−ϵ≥ρ(γ(h(x¹)−ϵ))=γρ(h(x¹)−ϵ),

where in the last equality the positive homogeneity property of ρ was used since γ∈(0,1). Since ϵ>0 is a constant, translational invariance property of ρ yields:

ρ°πρ(h(x²)−ϵ≥ρ(γ(h(x¹)−ϵ)).

Moreover, from inequality (17), we infer

ρ°ρ(h(x²)−ϵ≥γ(ρ(h(x¹))−ϵ)=γ²(h(x₀)−ϵ).

Thus, by induction, we see that at time step t, the following inequality holds

ρ^{t}(h(x^{t}))−ϵ≥γ^{t}(h(x₀)−ϵ).

Taking ϵ to the right-hand side and noting that the left-hand side of the above inequality is equal to ρ_{0,t}(0, . . . , h(x^{t})), yields the following inequality:

ρ_{0,t}(0, . . . , h(x^{t}))≥γ^{t}(h(x⁰)−ϵ)+ϵ. (19)

Since 0<γ<1 and x⁰∈X\S, e.g., h(x⁰)<0, as t increases x^{t} approaches S in the dynamic risk measure ρ_{0,t}, because by definition h(x^{t})≥0 implies x^{t}∈S. Hence, S is ρ-reachable in finite time. By definition, x^{t} reaches S at least at the boundary by t* when \tilde{h}(x^{t})=0. Substituting \tilde{h}(x^{t})=0 in (19) yields:

0≥γ^{t*}(h(x₀)−ϵ)+ϵ, (20)

where ρ_{0,t}(0, . . . , h(x^{t*}))=ρ_{0,t}(0, . . . ,0)=0. Re-arranging the term and noting that h(x₀)≤0 and therefore h(x₀)−ϵ≤0, yields:

$$\frac{ε}{ε - h ( {x}_{0} )} \leq {γ}^{t} .$$

Taking the logarithm of both sides of the above inequality gives log

$$( \frac{ε}{ε - h ( {x}_{0} )} ) \leq t log ( γ ) ,$$

or equivalently:

$$- log ( \frac{ε - h ( {x}^{0} )}{ε} ) \leq - t log ( \frac{1}{γ} ) .$$

### Since 0<γ<1, log

$$( \frac{1}{γ} )$$

is a positive number. Dividing both sides of the inequality above with the negative number −log

$$( \frac{1}{γ} )$$

obtains t≤log

$$( \frac{ε - \tilde{h} ( {b}^{0} )}{ε} ) / log ( \frac{1}{ρ} ) .$$

The upper bound described by inequality (16) in Theorem 2 is dependent on the two parameter γ and ϵ. In some embodiments, 0<γ<1 and carry out a line search over e until the finite-time RCBF condition (15) does not hold anymore. Then, the corresponding t* may be chosen as the upper-bound on the earliest time the solutions can enter the goal set [symbol] .

If (15) is true then a user's command for a change of state of a moveable device is safe. Otherwise, if (15) is false then a user's command for a change of state is not-safe. When the user's command for a change of state of the moveable device is safe then the system can control the moveable device in the way that the user has commanded. If the user's command for the change of state of the moveable device is not-safe then the user's command may be altered until a safe change of state is reached. When a safe change of state is reached then the system can control the moveable device with this altered user's command.

### Boolean Compositions of RCBFs

RCBFs and finite-time RCBFs may be utilized as means to verify ρ-safety and ρ-reachability, respectively. Disclosed are conditions for verifying ρ-safety and ρ-reachability for Boolean compositions of several control barrier functions.

Proposition 1: Let Sᵢ={x∈ [symbol] ⁿ|hᵢ(x)≥0}, i=1, . . . , k denote a family of safe sets with the boundaries and interior defined analogous to S in (6) and ρ be a given dynamic coherent risk measure. Consider the discrete-time system (5). If there exist α∝∈(0,1) such that

$$ρ ( {min}_{i = 1 , … , k} {h}_{i} ( {x}^{t + 1} ) ) \geq α {min}_{i = 1 , … , k} {h}_{i} ( {x}^{t} ) \qquad ( 21 )$$

then the set {x∈ [symbol] ⁿ|Λ_{i=1, . . . ,k}(hᵢ(x)≥0} is ρ-safe. Similarly, if there exist a α∈(0,1) such that

$$ρ ( {max}_{i = 1 , … , k} {h}_{i} ( {x}^{t + 1} ) ) \geq α {max}_{i = 1 , … , k} {h}_{i} ( {x}^{t} ) \qquad ( 22 )$$

then the set {x∈ [symbol] ⁿ|V_{i=1, . . . , k}(hᵢ(x)≥0)} is ρ-safe.

We next propose conditions for risk-sensitive finite-time reachability of sets composed of Boolean compositions of several functions h as described in (6).

Proposition 2. Let Sᵢ={x∈ [symbol] ⁿ|hᵢ(x)≥0}, i=1, . . . , k denote a family of sets with the boundaries and interior defined analogous to [symbol] (6) and ρ be a given dynamic coherent risk measure. Consider the discrete-time system (5). If there exist constants 0<γ<1 and ϵ>0 such that

$$ρ ( {min}_{i = 1 , … , k} {h}_{i} ( {x}^{t + 1} ) ) - γ {min}_{i = 1 , … , k} {h}_{i} ( {x}^{t} ) \geq ε ( 1 - γ ) \qquad ( 23 )$$

then the set {x∈ [symbol] ⁿ|Λ_{i=1, . . . , k}(hᵢ(x)≥0} is ρ-reachable. Then, there exists a constant t* satisfying

$${t}^{*} \leq log ( \frac{ε - {min}_{i = 1 , … , k} {h}_{i} ( {x}^{0} )}{ε} ) / log ( \frac{1}{γ} ) , \qquad ( 24 )$$

such that if x⁰∈X/∪_{i=1, . . . ,k}Sᵢ then x^{t*}∈∩_{i=1 , . . . ,k}Sᵢ. Similarly, the disjunction case follows by replacing min with max in (23) and (24).

### Example Simulation Results

In order to illustrate the results of these risk-aware guarantees, the method was applied to a cart-pole (a pole attached to a cart), modeled as a nonlinear, control-affine discrete-time system.

$${x}^{t + 1} = {x}^{t} + [ \begin{matrix}{v}_{x} \\ \dot{θ} \\ \frac{{u}^{t} + {m}_{p} sin θ ( l {\dot{θ}}^{2} + g cos θ )}{{m}_{c} + {m}_{p} {sin}^{2} θ} \\ \frac{\begin{matrix}{u}^{t} cos θ - {m}_{p} l {\dot{θ}}^{2} cos θ sin θ - \\ ( {m}_{c} + {m}_{p} ) g cos θ\end{matrix}}{l ( {m}_{c} + {m}_{p} {sin}^{2} θ )}\end{matrix} ] {Δ}_{t} + {w}^{t} \qquad ( 25 )$$

where vₓ is the current positional velocity of the cart-pole, \dot{θ} is the angular velocity of the cart-pole, u^{t} is the applied force on the cart-pole, mₚ is the mass of the pole, θ is the angle of the cart-pole, l is the length of the pole, g is a gravitational constant, m_{c} is the mass of the cart, Δₜ is the time step, and w^{t} is a random disturbance on the cart-pole. The disturbance w^{t} ∈W enters the system linearly, and is described by a pmf over the states. This could include the modeling error from this Euler-approximated discrete-time model, but in this case, it is a simple pmf normally distributed around 0 with standard deviation σ={0.05, 0.05, 0.2, 0.2} for the four states x=[pₓ, θ, vₓ, θ].

The safety set (the RCBF) may be described by

h(x^{t})=−2aₘₐₓpₓ^{t}−vₓ^{t}^{²}sgn(vₓ^{t}) (26)

where aₘₐₓ is the maximum acceleration of the cart-pole, and pₓ^{t+1}−p₀ is the relative position of the cart-pole to a barrier constraint, and vₓ^{t+1} is the velocity of the moveable device. where aₘₐₓ>0 is a tuneable parameter that designates the maximum linear acceleration at any point. This function is positive when pₓ<0, but allows h(x^{t})>0 when pₓ>0 if vₓ is sufficiently negative. It flows that the safety set for x^{t+1} is:

h(x^{t+1})=−2aₘₐₓ(pₓ^{t+1}−p₀)−vₓ^{t+1}^{²}sgn(vₓ^{t+1}),

where aₘₐₓ is the maximum acceleration of the cart-pole, pₓ^{t+1}−p₀ is the altered relative position of the cart-pole to a barrier constraint, and vₓ^{t+1} is the altered velocity of the cart-pole.

While this safety set is nonlinear in the control inputs, the one-step nature of this optimization problem results in no issues solving such a program in real-time, using modern solvers such as IPOPT or NLOPT. In some examples, nonlinear CBFs can be linearized to result in an affine RCBF constraint, with the error included in the stochastic uncertainty to result in formal safety guarantees.

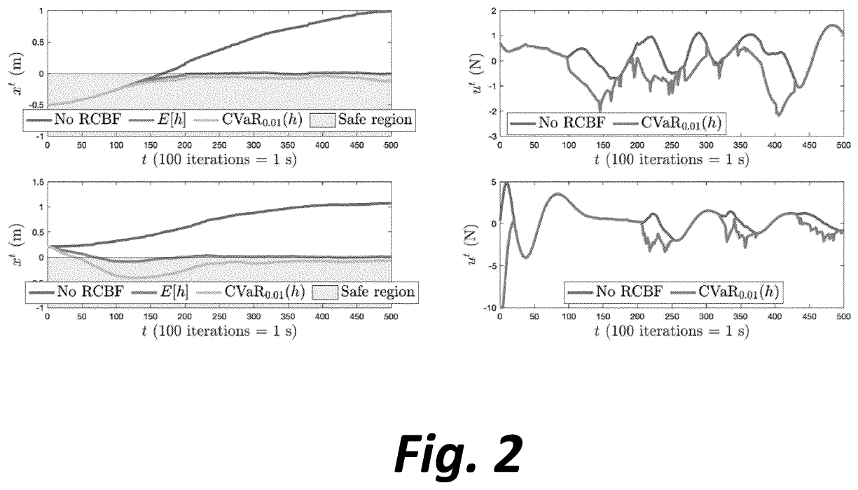

The RCBF was solved using PAGMO's integrated SLSQP solver from NLOPT. Each solution took roughly 0.7 ms to compute on a modern laptop, resulting in a maximum control frequency of 1428 Hz. Three trajectories are shown in FIG. 2. FIG. 2 is simulation results for the cart-pole system with no RCBF filter, and with standard RCBF (top) and finite-time RCBF (bottom) filters using total conditional expectation and CVaR. The desired trajectory shows the trajectory with only the nominal controller, which clearly surpasses the safe set at x=0. The trajectory corresponding to [symbol] [h] was filtered subject to the total conditional expectation coherent risk measure, which also corresponds to CVaR with β=1. While this filter guarantees safety in the expectation, safety may be frequently violated due to the stochastic uncertainty. Finally, the trajectory corresponding to CVaR with β=0.01 results in safety over the entire trajectory.

Similarly, FIG. 2 also demonstrates the same three trajectories with the finite-time reachability RCBF. Specifically, constants γ=0.05 and ϵ=0.1 may be utilized, with an initial safety violation of h(x⁰)=−0.2. From (16), this suggests a t*≤0.3667s. While this is not reflected in the plot, which only shows pₓ^{t} rather that h(x^{t}), h(x^{t*})>0 at t*=0.08 s.

### Example Network System

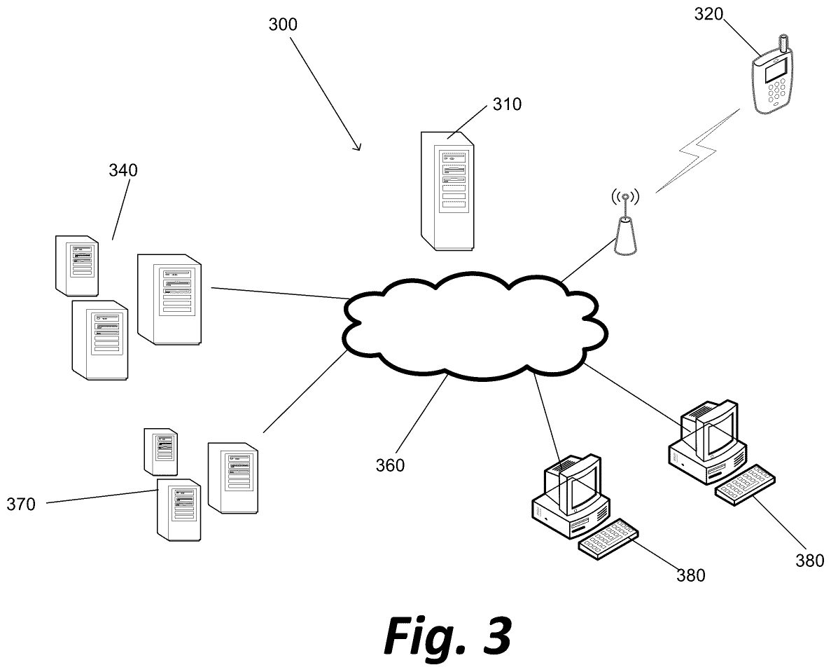

FIG. 3 illustrates an example of safety system for computing a safe state for a moveable device in accordance with an embodiment of the invention. Network 300 includes a communications network 360. The communications network 360 is a network such as the Internet that allows devices connected to the network 360 to communicate with other connected devices. Server systems 310, 340, and 370 are connected to the network 360. Each of the server systems 310, 340, and 370 is a group of one or more servers communicatively connected to one another via internal networks that execute processes that provide cloud services to users over the network 360. One skilled in the art will recognize that the optimization system may exclude certain components and/or include other components that are omitted for brevity without departing from this invention.

For purposes of this discussion, cloud services are one or more applications that are executed by one or more server systems to provide data and/or executable applications to devices over a network. The server systems 310, 340, and 370 are shown each having three servers in the internal network. However, the server systems 310, 340 and 370 may include any number of servers and any additional number of server systems may be connected to the network 360 to provide cloud services. In accordance with various embodiments of this invention, the optimization system that uses systems and methods that optimizes photonic devices while enforcing fabrication constraints in accordance with an embodiment of the invention may be provided by a process being executed on a single server system and/or a group of server systems communicating over network 360.

Users may use personal devices 380 and 320 that connect to the network 360 to perform processes that optimizes photonic devices while enforcing fabrication constraints in accordance with various embodiments of the invention. In the shown embodiment, the personal devices 380 are shown as desktop computers that are connected via a conventional “wired” connection to the network 360. However, the personal device 380 may be a desktop computer, a laptop computer, a smart television, an entertainment gaming console, or any other device that connects to the network 360 via a “wired” connection. The mobile device 320 connects to network 360 using a wireless connection. A wireless connection is a connection that uses Radio Frequency (RF) signals, Infrared signals, or any other form of wireless signaling to connect to the network 360. In the example of this figure, the mobile device 320 is a mobile telephone. However, mobile device 320 may be a mobile phone, Personal Digital Assistant (PDA), a tablet, a smartphone, or any other type of device that connects to network 360 via wireless connection without departing from this invention.

As can readily be appreciated the specific computing system used to optimizes photonic devices while enforcing fabrication constraints is largely dependent upon the requirements of a given application and should not be considered as limited to any specific computing system(s) implementation.

### Example Safety Computation Element

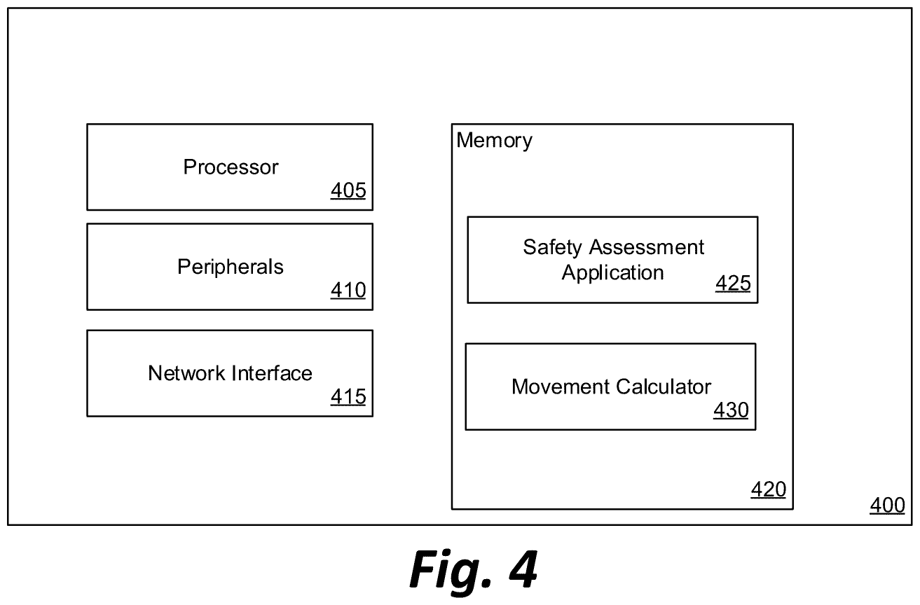

FIG. 4 illustrates an example of a safety computation element that executes instructions to perform processes that computes safety for moveable devices in accordance with an embodiment of the invention. Safety computation elements in accordance with many embodiments of the invention can include (but are not limited to) one or more of mobile devices, cameras, and/or computers. Safety computation element 400 includes processor 405, peripherals 410, network interface 415, and memory 420. One skilled in the art will recognize that the safety computation element may exclude certain components and/or include other components that are omitted for brevity without departing from this invention.

The processor 405 can include (but is not limited to) a processor, microprocessor, controller, or a combination of processors, microprocessor, and/or controllers that performs instructions stored in the memory 420 to manipulate data stored in the memory. Processor instructions can configure the processor 405 to perform processes in accordance with certain embodiments of the invention.

Peripherals 410 can include any of a variety of components for capturing data, such as (but not limited to) cameras, displays, and/or sensors. In a variety of embodiments, peripherals can be used to gather inputs and/or provide outputs. The safety computation element 400 can utilize network interface 415 to transmit and receive data over a network based upon the instructions performed by processor 405. Peripherals and/or network interfaces in accordance with many embodiments of the invention can be used to gather inputs that can be used to optimize photonic devices while enforcing fabrication constraints.

Memory 420 includes a safety assessment application 425 and a movement calculator 430. The safety assessment application 425 and the movement calculator 430 in accordance with several embodiments of the invention can be used to computes safety for moveable devices.

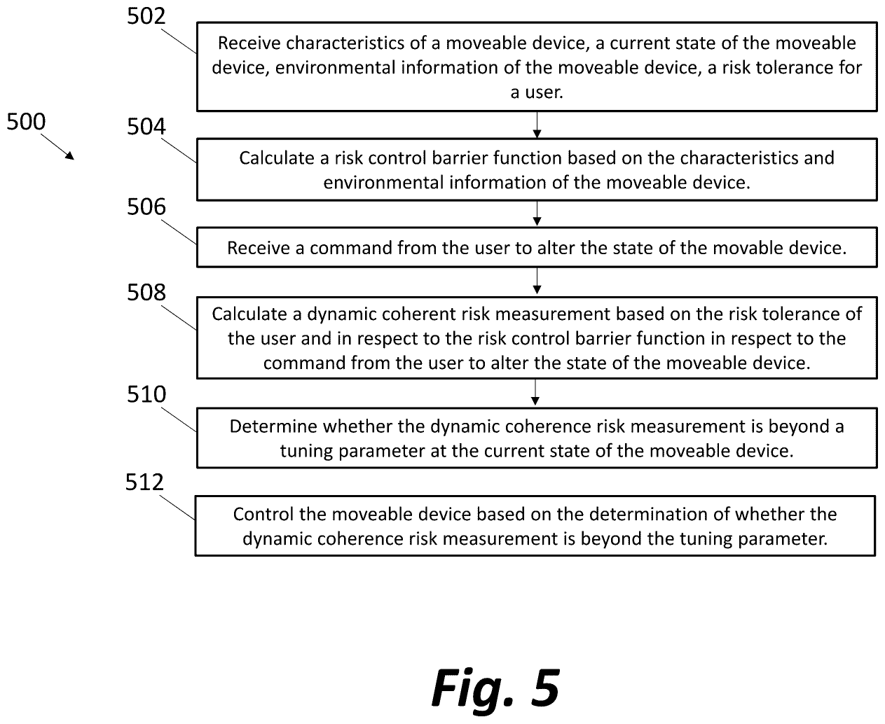

The safety assessment application 425 and movement calculator 430 may be used to perform the methods described above and the methods described below in FIG. 5. For example, the safety assessment application 425 may receive characteristics of a moveable device, the current state of the moveable device, environmental information of the moveable device, and a risk tolerance for a user. The safety assessment application 425 may also receive a command from the user to alter the state of the moveable device. The safety assessment application 425 may calculate a risk control barrier function based on the characteristics and environmental information of the moveable device. The safety assessment application 425 may calculate a dynamic coherent risk measurement based on the risk tolerance of the user and in respect to the risk control barrier function in respect to the command from the user to alter the state of the moveable device. The safety assessment application 425 may determine whether the dynamic coherence risk measurement is beyond a tuning parameter at the current state of the moveable device.

The environmental information of the moveable device may include a barrier, a slope, a hill, and/or a user defined distance from the barrier.

The movement calculator 430 may receive the determination of whether the dynamic coherence risk measurement is beyond the tuning parameter from the assessment application 425 and control the moveable device based on the determination of whether the dynamic coherence risk measurement is beyond the tuning parameter.

Although a specific example of element 400 is illustrated in this figure, any of a variety of safety elements can be utilized to perform processes computing a safe state for a moveable device described herein as appropriate to the requirements of specific applications in accordance with embodiments of the invention.

Example Optimization Method

FIG. 5 illustrates a flow chart for a method for controlling a moveable device in accordance with an embodiment of the invention. This method may be performed utilizing the safety computation element 400 described in connection with FIG. 4. The method 500 includes receiving (502) characteristics of a moveable device, a current state of the moveable device, environmental information of the moveable device, a risk tolerance for a user.

The method 500 includes calculating (504) a risk control barrier function based on the characteristics and environmental information of the moveable device. The method 500 includes receiving (506) a command from the user to alter the state of the moveable device. The command from the user of alter the state of the moveable device includes a change of speed, direction, angle, and/or force on the moveable device. The method 500 further includes calculating (508) a dynamic coherent risk measurement based on the risk tolerance of the user and in respect to the risk control barrier function in respect to the command from the user to alter the state of the moveable device. The dynamic coherent risk measurement may be calculated by:

ρ(h(x^{t+1}))

where h(x^{t+1}) is the risk control barrier function and x^{t+1} is the altered state of the moveable device. For example, a user of alter the state of the moveable device may include a force u^{t} exerted on the moveable device which may result in a projected state of x^{t+1}.

The method 500 further includes determining (510) whether the dynamic coherence risk measurement is beyond a tuning function at the current state of the moveable device. The tuning function may be calculated by:

α(h(x^{t})),

where x^{t} is the current state of the moveable device. Determining whether the dynamic coherence risk measurement is beyond a tuning function at the current state of the moveable device may involve:

α(h(x^{t+1}))≥α(h(x^{t})), ∀x^{t}∈X.

When the dynamic coherent rise measurement is determined to be less than the tuning function, the moveable device may be controlled in a way which is different than the command from the user, which may include a modified force u^{t} exerted on the moveable device. The tuning function may be a function composed with h(x^{t}), a measure of the safety of the function at time state x at time t. The tuning function may be a function of the safety at a current state of the moveable device.

The method 500 further includes controlling (512) the moveable device based on the determination of whether the dynamic coherence risk measurement is beyond the tuning parameter. When the dynamic coherence risk measurement is determined to be less than the tuning parameter, the moveable device may be controlled in a way which is different than the command from the user. When the dynamic coherence risk measurement is determined to be greater than or equal to the tuning parameter, the moveable device may be controlled in line with the command from the user of the movement.

What is claimed is:

1. A system for controlling a moveable device comprising:
a processor; and
memory containing programming executable by the processor, wherein the programming is configured to:
receive characteristics of the moveable device;
receive a current state of the moveable device;
receive environmental information of the moveable device;
receive a risk tolerance for a user;
calculate a risk control barrier function based on the characteristics and environmental information of the moveable device;
receive a command from the user to alter the state of the moveable device;
calculate a dynamic coherent risk measurement based on the risk tolerance of the user and in respect to the risk control barrier function in respect to the command from the user to alter the state of the moveable device;
determine whether the dynamic coherence risk measurement is beyond a tuning parameter at the current state of the moveable device; and
control the moveable device based on the determination of whether the dynamic coherence risk measurement is beyond the tuning function.

2. The system of claim 1, wherein the dynamic coherent risk measurement is calculated by:
ρ(h(x^{t+1})),
where h(x^{t+1}) is the risk control barrier function and x^{t+1} is the altered state of the moveable device.

3. The system of claim 2, wherein the tuning function is a function of the safety at the current state of the moveable device.

4. The system of claim 3, wherein the tuning function is calculated by:
α(h(x^{t})),
where x^{t} is the current state of the moveable device and where h(x^{t}) is the safety at the current state of the moveable device.

5. The system of claim 4, wherein the tuning function α(h(x^{t})) is a constant.

6. The system of claim 4, wherein determining whether the dynamic coherence risk measurement is beyond a tuning parameter at the current state of the moveable device involves:
α(h(x^{t+1}))≥α(h(x^{t})), ∀x^{t}∈X.

7. The system of claim 2, wherein the tuning function is calculated by:
ϵ(1−γ)+γh(x^{t}),
where ϵ and γ are constants, where 0<γ<1 and ϵ>0, where x^{t} is the current state of the moveable device, and where h(x^{t}) is the safety at the current state of the moveable device.

8. The system of claim 7, wherein determining whether the dynamic coherent risk measurement is beyond a tuning parameter at the current state of the moveable device involves:
ρ(h(x^{t+1}))−γh(x^{t})≥ϵ(1−γ), ∀x^{t}∈X.

9. The system of claim 6, wherein the moveable device is a cart-pole including a pole attached to a cart and wherein the altered state of the moveable device is defined by:
$${x}^{t + 1} = {x}^{t} + [ \begin{matrix}{v}_{x} \\ \dot{θ} \\ \frac{{u}^{t} + {m}_{p} sin θ ( l {\dot{θ}}^{2} + g cos θ )}{{m}_{c} + {m}_{p} {sin}^{2} θ} \\ \frac{{u}^{t} cos θ - {m}_{p} l {\dot{θ}}^{2} cos θ sin θ - ( {m}_{c} + {m}_{p} ) g cos θ}{l ( {m}_{c} + {m}_{p} {sin}^{2} θ )}\end{matrix} ] {Δ}_{t} + {w}^{t} ,$$
where vₓ is a current positional velocity of the moveable device, \dot{θ} is an angular velocity of the moveable device, u^{t} is an applied force on the moveable device, mₚ is a mass of the pole, θ is an angle of the moveable device, l is a length of the pole, g is a gravitational constant, m_{c} is the mass of the cart, Δₜ is a time step, and w^{t} is a random disturbance on the moveable device.

10. The system of claim 9, wherein the risk control barrier function in respect to the command from the user to alter the state of the moveable device is defined by:
h(x^{t+1})=−2a ₘₐₓ(pₓ^{t+1}−p₀)−vₓ^{t+1}^{²}sgn(vₓ^{t+1}),
where aₘₐₓ is a maximum acceleration of the moveable device, pₓ^{t+1}−p₀ is an altered relative position of the moveable device to a barrier constraint, and vₓ^{t+1} is the altered velocity of the moveable device.

11. The system of claim 1, wherein the dynamic coherence risk measurement is determined to be less than the tuning parameter and the moveable device is controlled in a way which is different than the command from the user.

12. The system of claim 1, wherein the dynamic coherence risk measurement is determined to be greater than or equal to the tuning parameter and the moveable device is controlled in line with the command from the user to alter the state of the moveable device.

13. The system of claim 1, wherein the moveable device is a boat, a plane, a drone, a car, or a robot.

14. The system of claim 1, wherein the state of the moveable device is a position, speed, and/or traveling direction of the moveable device.

15. The system of claim 1, wherein the environmental information of the moveable device includes a barrier, a slope, a hill, and/or a user defined distance from the barrier.

16. The system of claim 1, wherein the command from the user of alter the state of the moveable device includes a change of speed, direction, angle, and/or force on the moveable device.

17. A method for controlling a moveable device, the method comprising:
receiving characteristics of the moveable device;
receiving a current state of the moveable device;
receiving environmental information of the moveable device;
receiving a risk tolerance for a user;
calculating a risk control barrier function based on the characteristics and environmental information of the moveable device;
receiving a command from the user to alter the state of the moveable device;
calculating a dynamic coherent risk measurement based on the risk tolerance of the user and in respect to the risk control barrier function in respect to the command from the user to alter the state of the moveable device;
determining whether the dynamic coherence risk measurement is beyond a tuning parameter at the current state of the moveable device; and
controlling the moveable device based on the determination of whether the dynamic coherence risk measurement is beyond the tuning function.

18. The method of claim 17, wherein the dynamic coherent risk measurement is calculated by:
ρ(h(x^{t+1})),
where h(x^{t+1}) is the risk control barrier function and x^{t+1} is the altered state of the moveable device.

19. The method of claim 18, wherein the tuning function is calculated by:
α(h(x^{t})),
where x^{t} is the current state of the moveable device.

20. The method of claim 19, wherein determining whether the dynamic coherence risk measurement is beyond a tuning parameter at the current state of the moveable device involves:
ρ(h(x^{t+1}))≥α(h(x^{t})), ∀x^{t}∈X.
